(19) United States
(12) Patent Application Publication
(10) Pub. No.: US 2017/0265670 A1
(43) Pub. Date: Sep. 21, 2017

(54) MINI-JUICER FOR FOODS IN PORTIONS OF LESS THAN A HALF (1/4 - 1/8 AND IRREGULAR PORTIONS) AND METHOD OF PRODUCTION AND ASSEMBLY THEREOF WITH REMOVABLE PARTS

(71) Applicant: John Javier ORTIZ BERRIO, Envigado, OT (CO)

(72) Inventor: John Javier ORTIZ MARTINEZ, Envigado (CO)

(21) Appl. No.: 15/505,556

(22) PCT Filed: Aug. 20, 2015
(86) PCT No.: PCT/IB2015/056319

§ 371 Date: Apr. 12, 2017

(30) Foreign Application Priority Data
Aug. 22, 2014 (CO) 14-184714

(51) Int. Cl. A47J 19/00; A47J 19/02

(52) U.S. Cl. CPC A47J 19/00; A47J 19/02

(57) ABSTRACT

The following invention refers about LESS THAN ONE-HALF PORTION FOOD MINI-JUICER (¼-⅛ AND IRREGULARS) with removable pieces offering a handle which has a long or short configuration and is joined to a cavity with a press way and a receptacle that is like a container to store the juice which are joined by a hinge; which are in turn used in the kitchen especially with the mini-juicer manufacturing, citric, fruits and food product squeezer (lemon, oranges, among others) in ¼, ⅛ and irregulars or minor parts portions that have that measure and are placed between them and their manufacturing process and set up with its removable pieces.

### PRIOR ART

The following invention is related to home line products, particularly with the manufacturing of a mini-juicer, citric, fruits and food products (lemons, oranges, among others) squeezer in ¼-⅛ servings and irregulars or minor parts having that measure or are among them and its manufacturing process and assembly with removable parts.

Which we found in the following international classifications:
A47J 19/06 Vegetables Juicer
A47J 19/02 Citric Juicer; Juicer device to extract other fruits juicer

### BACKGROUND

At present, there are multiple juicer forms designed to squeeze cut in half citric forcing them to be bigs, expensive and uncomfortable; without attending actual needs of diversify products and reduce costs also avoiding juice waste, for example lemon one, which is portioned in ¼ and ⅛ pieces or irregulars or food products, aside from offering its service in restaurants of squeezers due to its cost or because they are stolen, which results in squeezing discomfort leaving fruit juice unused apart from splashes and poor hygiene produce. Which currently exists, are as follow:

ES1018885 Patent shows a design that allows citric juice to splash everywhere because it is open and the squeezer part is included in a plate or tray which is constituted by 3 parts bigger than their own squeezer which stores liquid sparsely. Its design is like a ridge plate or base for the juice not to spill, the juicer element (lever) is join to the plate through a third part or pin causing a tedious and difficult assembly and disassembly. It is manufactured in stainless stiff sheet what requires a large support area for its management.

In this patent document and in general in current manual squeezers it is required to use hands or a base for its functioning.

To empty the juice, nozzles are used because of large borders that helps the pour. In our invention, as its emptying is compressed, more accurate without nozzles, because its emptying could be done in the fund with the small holes; or through the superior edge (without holes in the fund) which would be the most practical thing to do as juice could be conserved and there won't be any spill. Squeeze walls are concave, convex and circle like conventional used to squeeze half a fruit.

In our depth and collect invention, who is calculated to keep juice without spilling it or without requiring a container enables juice to concentrate in the less possible space; could be manufactured not only in two parts but in one part and if needed could be done in three or more parts which won't be functional nor economic ; it doesn't requires assembly within three parts but a fast and simple joint between two parts which could be done by the user allowing a fast and deep clean manufactured in any kind of flexible semi-rigid material even in soft goods.

Other difference of our invention is its effectiveness even using it only with the fingers; with a little effort not using the whole hand.

Flat walls are used to have more effectiveness in our invention with the minimum of concave and convex curvatures. Although walls can be manufactured with different shapes, optimum are closely related with the way the cut is done in a fruit (normally spherical shape or similar) when it is cut in ¼ (like a croissant or helmet) or ⅛ like a pyramidal triangle.

All the above mentioned is the reason why the manufacturing of Juicer Patent ES1018885 is more expensive and less functional than our invention.

Patent ES1063170 offers a design practically for table using due to the big size and its flashy, composed by three parts that needs to be assemble plus the filter; uses just a flat side for squeezing with the lever which has a reinforced flat face that squeezes the fruit against the flat wall by operating the lever; it requires an external container to store the juice; due to all the above mentioned, its manufacturing is really expensive, the cleaning is wasteful as it has been manufactured with complex parts.

### Advantages of our Invention Against Technique Status:

Efficient, practical, hygienic, less market cost and disposable (unique in the market).
Permit optimal juice extraction with less effort.
For pieces minor to the half of the product (¼-⅛ and irregulars of citric or food product among others).
As it could be assemble, removable and interchangeable it could be manufactured for many pieces looking for major simplicity and squeezer economy which could be one or two parts.
Allows to be used for a child without major effort.
Hygiene as it avoids the direct contact squeezing with the fingers or hands little lemon portions or others.
Security as sometimes are used sharp cut elements like forks or knifes to exercise pressure and squeeze.
For convenience as it avoids spilling.
Ease and speed cleaning (disposable included).
The juicer can store the juice without an extra container, it is sustained in the table alone.
It is stored and transported with ease and economy, for its minimum weight and size in each type.
Its design simplify its manufacturing saving raw material, time, labor force which results in a decrease of output costs even allowing its disposal.
Due to its low cost, people with low income can buy it, they can also reach new business providing value added into their service with a low cost decreasing fruit consumption optimizing their consumption or other products consumption.
Could be manufactured in one part and different figures.
Could be manufactured in: wood, metal, rubber or plastic, among others.
If Mini-Juicer is used as a simple jug (without holes in the fund) or the option with pourer in order to have more hygiene and functionality to keep juice inside the container, being used when it is needed.
Cup Juicer for its use in cocktail lounge.
Our setting is like croissant or pyramidal triangle, looking for more efficiency in the device and the product.
It does not need any piece to be join (pin or cotter), it is constituted by two parts which are easy and fast to assembly, or just one part.
There is no need to have a duct to empty the juice as it could be done for any superior edge from the base.
Could be completely clean as it can be totally disassemble with great facility.
It presents the equal shape to the fruit cut done to the fruit, is the smallest and lightest who results in an economic and disposable output.
Our design allows that its manufacturing is really simple and practical.
The design also allows little space for storing and transporting.

### Invention Goal:

The goal of this invention is to obtain and achieve the most efficient and practical squeezer, hygienic and with the lowest cost on the market offers even disposable (unique in the market).

1—We took into account which would be the most efficient way to cut a fruit that permits an optimum extraction of the juice with the less effort and, as a result, we found that cutting ¼ or ⅛ or irregulars citric or food product or others less than half the fruit, it presents less resistance to extract the juice. It was also wanted to have efficiency and reduce the wastes.

Special consideration was given to the design for it to fulfill these requirements:
1. The design is done regarding the shape and size of the fruit cut, which gains efficiency, being the most functional the one of ¼ and ⅛ of the citric or food product that needs to be squeeze, since with a different but appropriate cut which can get in these designs, it would be obtained the same.
2. As the design more efficiently is due to the shapes obtained with the output cut, it can have straight, concave or convex parts to gain more yield.
3. It could be manufactured for different parts but looking the squeezer's simplicity and economy (one or two parts).
4. Its design is practical.

Allows to be used without much effort even for a child.

Its design avoid people to use their hands or fingers while squeezing little lemon parts that spills everywhere.

The design also permits facility and speed regarding the cleaning of it (more hygiene).

The squeezer can keep juice without any external container for it, can dose without any kind of base to be supported on the table. It can stands on its own means.

### Cost Cutting:

1. Easy store and economic transportation for its minimum weight and size.
2. Manufacturing simplification saving raw materials, time, labor force which means less product cost even taking into account that is disposable.
3. The two or one part design does not require assembly thus the three parts one, which is commonly produce in the factory.
4. Spilling is avoided due to is design so juice is optimally use (spilling normally occurs when hands or fingers are used).
5. Due to its low cost, all social classes can buy it (people with low incomes or companies).

### Other Advantages

1. Innovative because despite of many existent squeezers, this one is unique as there were not previous publicity of this new product which meet people needs.
2. Its design allows to squeeze ¼ ⅛ or citric irregulars or food product or less even pieces of different sizes.
3. Its design it is adjusted to the way citric is cut so it is really comfortable and flexible to use.
4. Due to its two parts manufacturing (fast and easy assembly) there is no need of tools or pieces to join it.
5. All of these permits manufacture a very low cost squeezer with a long life even disposable regarding the materials used: wood, metal, rubber and plastic.
6. If MINI JUICER is used as a simple or pouring jar (without holes in the fund) is hygienic and functional as it keeps juice in the container and it can be used each time you need it.
7. With MINI JUICER all the fruit juice is obtained without spilling.
8. With the use of MINI JUICER there would be greater advantage of the juice so you will obtain economic benefits.
9. As it is a product of your style which is inexpensive as a result of its design, all the people could access to it.
10. Promoting its use the fruit cut could be done with a simple device that cuts in ¼ or ⅛ or irregulars that is the ideal shape for our squeezer gaining a continuous, simple and fast process. As a result, cost is reduce.
11. Cup squeezer for its use in cocktail lounge.

The squeezer for lemons or juice fruits and similar sizes or other food products, can be manufactured in any material (plastic, metal, or other similar offering the same service).

Operation: the squeezer has been created to extract lemon parts that are cut in different ways that is to say cut in half, like ¼ or ⅛ or citric irregulars or food product. The squeezer uses a fast hinge which allows both parts of it to improve cleaning or just one part. It can have two options: one with holes in the fund for the juice to go out through here and the other without holes in the fund so the juice goes out for the superior part rotating the squeezer. This can also have pouring like a jar.

### Production:

This fast hinge system supplies manufacturing because it does not requires edges or pins during its assembly to join both parts, like the known squeezers; this make it easier mold making and other manufacturing processes. Other squeezer system is done with a double hinge made of plastic that joins both elements of the squeezer in one piece coming out connected in the manufacturing. This system permits a squeezer without pressure handles its functioning pressing with the thumb finger into the superior piece in the hole holding with the ring and middle finger the other half of the squeezer (or you can press the squeezer with both hands like a castanet). In this two parts, it would be place the citric to be squeeze. It could be done with any kind of material, with a soft and flexible one like silicone (its resistance is very thin).

Technical Problems that are Solved:

Solved problems and advantages: squeeze small fruits (lemon, oranges, among others) that the size is less than their half, whom while hand squeeze juice is spill everywhere, splashing all even the eyes. They are small and middle squeezers, really comfortable to squeeze parts of ¼ and ⅛ and citric irregulars or food products without splashing. They do not need any protection like dishes or trays to avoid contamination in the place where they are store while they are not used (table, desk, carriage, among others). These squeezers are like jars. However, they can be done with the holes in the bottom sheet whereby juice gets out (which requires a container not to get dirty any place) It is used rotating it in order to the juice to come out through the upper part so it does not require any holes underneath, like the ones seen in the market. Other advantage is that they can be made really thin in comparison with others so that they are really inexpensive, for short term usage and disposables, though makes it functional and hygienic for restaurants or fast food shops (empanadas, sausages, etc.) Other very important problem that is solved with this device is that people or restaurants that buys it will cut the lemon or orange in constant measures which will make the process continuous and standard thereby economic. When squeezed with our article, you will benefit with all the juice without wasting or spilling it. With its usage, you will gain an economic long term benefit which results in a profit for your business.

### Improvements Aimed to be Introduced in the Current Technique Status and Basic Elements:

### Improvements:

fast hinges without assembling pins.

¼ and ⅛ or irregulars citric or food product SQUEEZER who does not splash as occurs when is done by hand or with the current squeezers; other improvements are:
Juicer size
Juicer with holes down
Juicer like jug without holes
Juicer like a cup for cocktail lounge usage
Juicer with limited useful life
Disposable juicer
Greater fruit use
Economic and functional product
Offers comfort and hygiene to the consumer
Fill in a need that is absent in the market
The juicer jar presents all the advantages above mentioned
The squeezer without handles results flexible, little and functional.

### Running:

It is assembled fitting together one part with the other joining them through the fast hinge, it is open in 90° and ¼-⅛ or citric irregulars or food product are introduced depending on their size and both handles are joined in order to squeeze the fruit. Then, the squeezer is twisted on the product that will receive the juice just as if the squeezer is a jug. If it has holes, there is no need to twist it. I mention it because it depends on the model you will use. When they are manufactured they are done heavy enough (suitable materials) in order to have a long lifespan, but they can be manufactured less heavy looking to reduce costs so they can be disposables.

### Other Choice:

MINI JUICER MODEL JAR, the way to use it is introducing the fruit serving (¼, ⅛ or citric irregulars or food product of lemon, orange, pineapple, etc.) and squeezing it. Add the desired liquor filling the cup that is formed with both juicer parts. Then, drink it normally as you drink of any cup; the upper squeezer has two windows to mix the juice with the liquor forming an exclusive cocktail depending on the liquor and fruit used (tequila, gyn, rum, spirits, etc.)

### FIGURE DESCRIPTION

FIG. 1: Squeezer isometric of ¼, upper and lateral view in two hinge half adjustable with long handle without holes in the receptacle.

FIG. 2: Squeezer isometric of ¼, upper and lateral view in two hinge half adjustable with long handle with holes in the receptacle.

FIG. 3: Squeezer isometric of ⅛, upper and lower view of type: small handle of two pieces with a cotter in the hinge without holes in the receptacle.

FIG. 4: Squeezer isometric of ⅛, upper and lower view of type: small handle of two pieces with a cotter in the hinge with holes in the receptacle.

FIG. 5: Squeezer isometric of ⅛, upper and lateral view of type: small handle of two pieces with a cotter in the hinge without holes in the receptacle.

FIG. 6: Squeezer isometric of ⅛, upper and lateral view of type: small handle of two pieces with a cotter in the hinge with holes in the receptacle.

FIG. 7: Circle squeezer isometric with small handle made of two pieces with an adjustable hinge with and without holes in the receptacle.

FIG. 8: Squeezer isometric made of one piece of ¼ ⅛ thimble type with and without holes in the receptacle.

FIG. 9: Squeezer isometric of two triangle shape parts with and without holes in the receptacle.

FIG. 10: Squeezer isometric of 2 parts of ¼ with and without holes in the receptacle.

FIG. 11: Squeezer isometric of 2 parts of ¼ with and without holes in the receptacle and sold cavity.

FIG. 12: Squeezer isometric with half round bottom with and without holes in the receptacle.

FIG. 13: Squeezer isometric cup type with and without holes in the receptacle.

FIG. 14: Isometric of the different types and textures, with squeezer handles of food divided into portions less than the half (¼-⅛ and irregulars).

FIG. 15: Isometric of the different types of food squeezer pouring of food divided into portions less than the half (¼-⅛ and irregulars).

FIG. 16: Squeezer isometric with windows in the pressing cavity.

FIG. 17: Isometric of the different types of squeezer hinges of food divided into portions less than the half (¼-⅛ and irregulars).

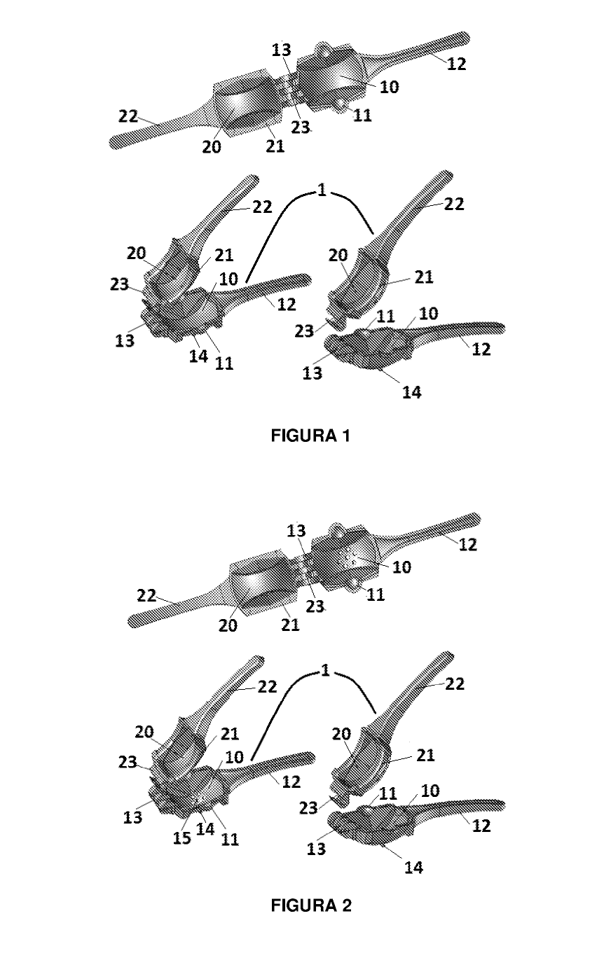

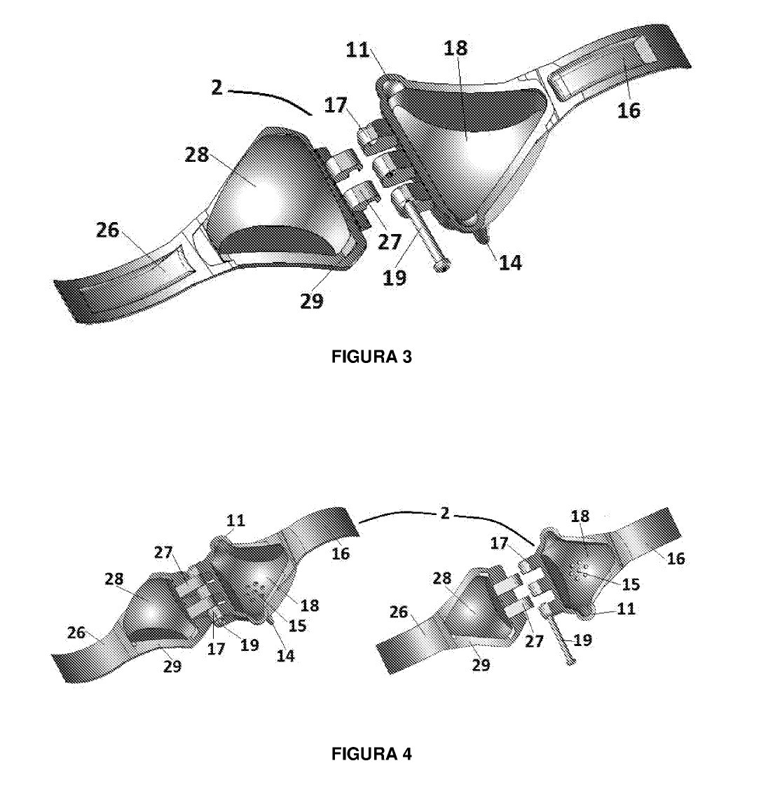

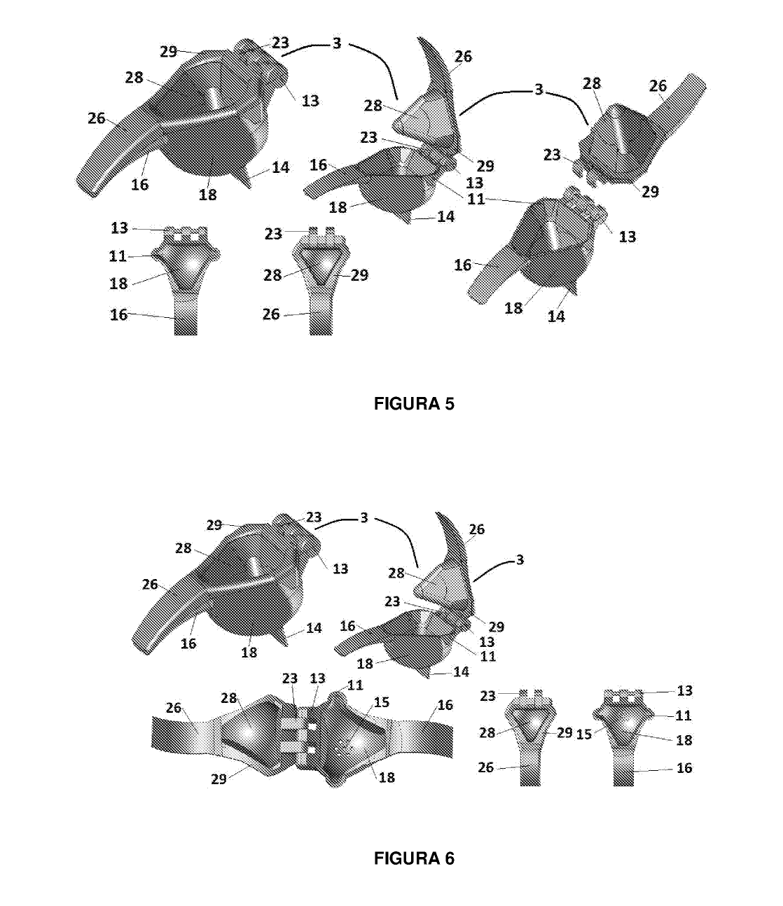

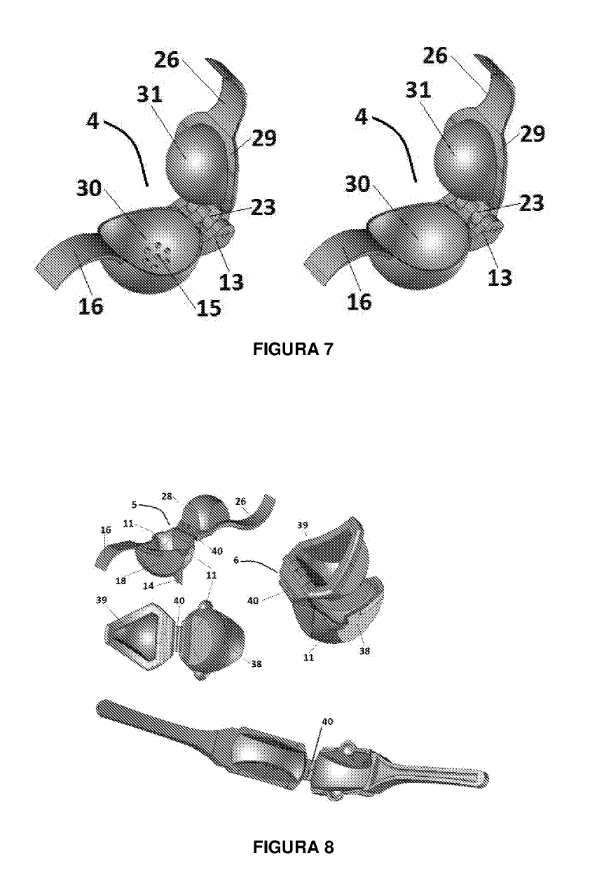

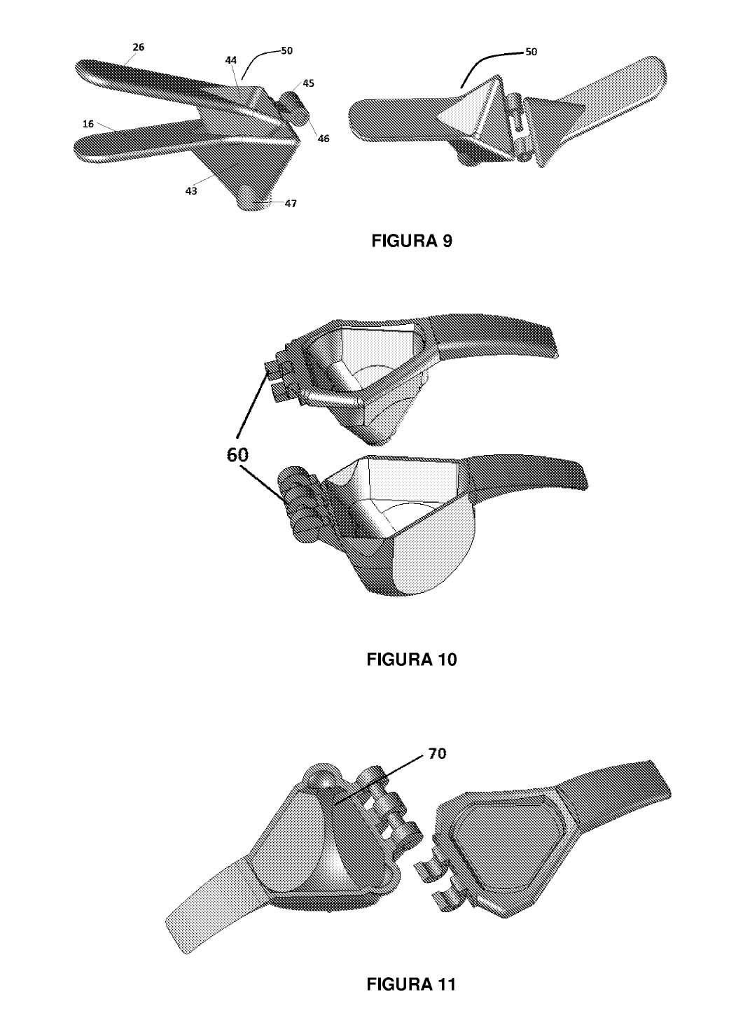

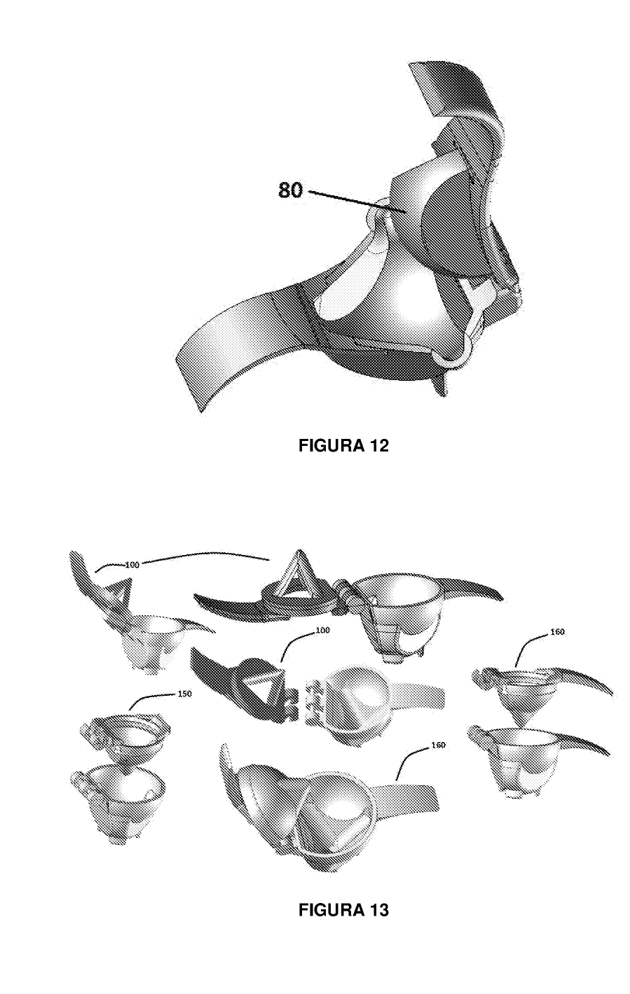

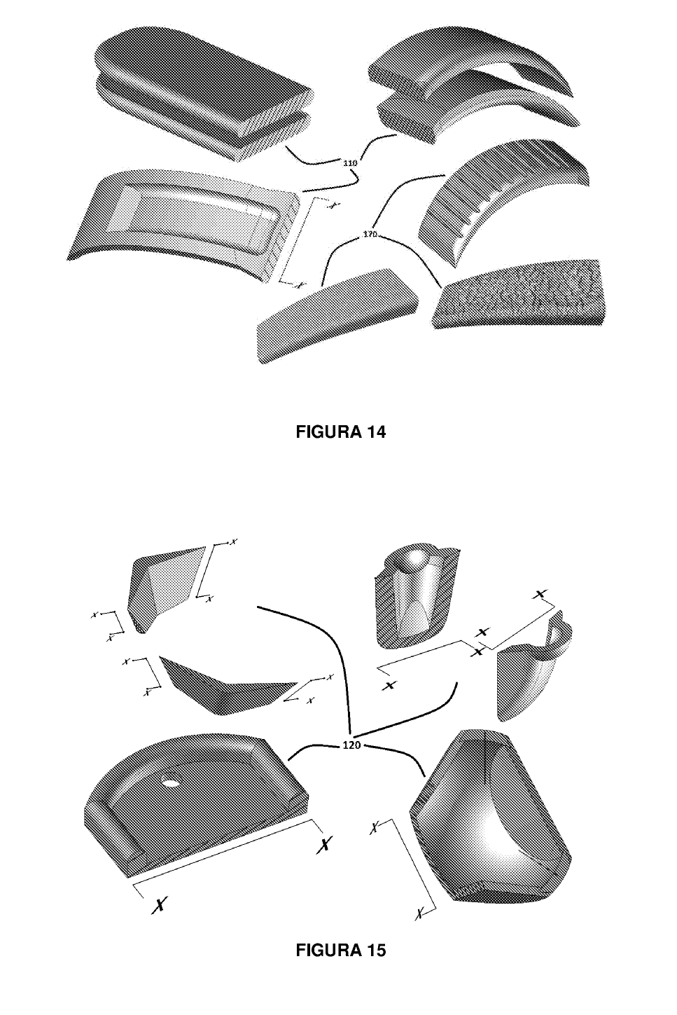

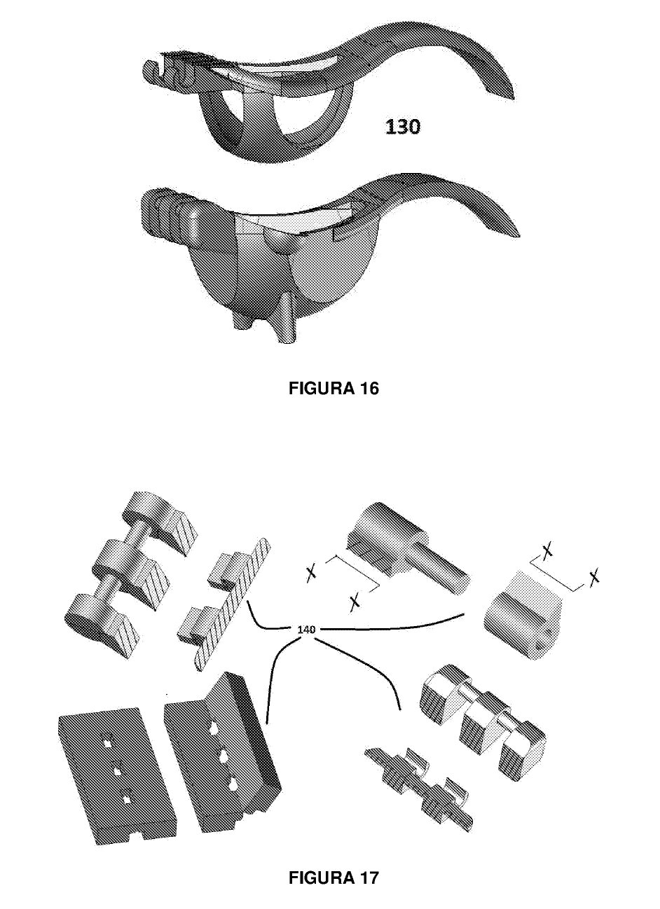

### BEST WAY TO CARRY OUT THE INVENTION

Mini-juicer of food divided into portions less than the half (¼-⅛ and irregulars) with removable parts presenting a handle which is elongated or short and is joined to a cavity through a press manner and has a receptacle as a juice container which works through a hinge where the setting (1) of the squeezer presents: of ¼ in two halves with handle where you can see: a (10) receptacle ¼ or (18) receptacle ⅛ or (30) circle receptacle or (38) thimble receptacle in one piece or (43) triangular receptacle of the juice of the squeezer, joined to two lateral walls inclined presenting borders (120) or types of pour spout (plain, dropper, triangular and circular) where the food portion is received and it is pressed by: a (20) ¼ press cavity or (28) ⅛ press cavity or (31) circle press cavity or (39) thimble cavity in one piece or (44) triangle press cavity or (70) solid press cavity which are joined through some (140) hinges (two pieces adjustable, like attachment, like edge and plain or one piece) join the cavity with the receptacle except for (2) two pieces squeezer with a cotter which will have an additional piece (19) cotter hinge pin where setting (40) Only hinge in one piece that permits having (5) the one piece squeezer or (6) thimble squeezer in one piece; it also presents (3) ⅛ squeezer with little handle and adjustable hinge , (4) Circle squeezer of 2 pieces with small handle and adjustable hinge, (50) Triangular squeezer with two pieces base with small handle and edge hinge, (60) Hinge squeezer flat type, (70) press solid cavity squeezer type, (80) Half round bottom squeezer in cavity and receptacle, (100) Cup or cocktail squeezer, (150) thimble cup without handle and (130) squeezer with press cavity with windows or (160) cup with close cavity.

Where (1) ¼ squeezer in two half with handles presents a (10) receptacle ¼ of the squeezer juice which in its base is rounded and joins it with (11) pouring pick of the receptacle through tilted walls that reach into the upper edge presented (120) Pick types (plain, dropper, triangular and circular) which is joined through a (13) lower hinge adjustable join directly to (10) ¼ receptacle of the squeezer juice, which has a round form carrying out a central edge of less diameter to fit it with (23) upper hinge connector which presents a half circumference adjustable with the central edge of part (13) lower adjustable hinge which can offer (140) Hinge types (two pieces adjustable, attachable, edge and plain or one piece) which, in turn, is in direct contact with (20) press cavity ¼ which presents the same geometrical arrangement that (10) receptacle of ¼ of squeezer juice unlike (21) outer edge of ¼ press cavity which is a plain perimeter face where the opposite extreme to the hinge is joined to (10) receptacle ¼ of the squeezer's juice; (12) long lower handle of the squeezer and (20) ¼ press cavity to (22) long upper handle of the squeezer which can present (110) Handle types (plain, rounded and with emptying), (170) handle textures; which can present (15) juice receptacle holes or close as a container; (10) squeezer ¼ juice receptacle in its lower part can present (14) lower reinforcements of the squeezer's receptacle as a base or flat base.

Where (2) ⅛ squeezer in two parts with a cotter presents (18) ⅛ squeezer juice receptacle which in its base is circle and joined with (11) pick of the receptacle through inclined walls that reach to the upper border showing (120) Pick types (plain, dropper, triangular and circular) which is joined through a (17) Lower hinge directly joined to (18) ⅛ of juice of the squeezer's receptacle, which has a round setting carried out by a hub for the (19) hinge pass pin to achieve the adjustment with (27) upper hinge cotter that presents a half circumference as a hub manner for (19) hinge pass pin which, at the same time, is in direct contact to (28) ⅛ press cavity which presents the same geometrical arrangement as (18) ⅛ juice receptacle different from (29) external side of the ⅛ press cavity which is a plain perimeter face where the hinge opposite extreme is join to (18) ⅛ juicer receptacle (16) squeezer's short lower handle and (28) ⅛ press cavity and (26) squeezer's upper short handle which can present (110) types of handles (plain, circle and with emptying), (170) handle's textures; which can present (15) Juicer receptacle holes or can be closed like a container; (10) ¼ juice receptacle in its lower side can have (14) bottom reinforcements of the juicer receptacle like a base or plain base.

(3) ⅛ squeezer with small handle made of two parts with adjustable hinge presents a (18) ⅛ juicer receptacle which in its base is circle and it is join with (11) receptacle nozzle through inclined walls that arrives to the upper edge and can have (120) Pick types (plain, dropper, triangular and circular) which is joined through a (13) lower hinge adjustable join directly to (10) ¼ receptacle of the squeezer juice, which has a round form carrying out a central edge of less diameter to fit it with (23) upper hinge connector which presents a half circumference adjustable with the central edge of part (13) lower adjustable hinge which can offer (140) Hinge types (two pieces adjustable, attachable, edge and plain or one piece) which, in turn, is in direct contact with (28) ⅛

Press Cavity which presents the same geometrical arrangement as (18) ⅛ squeezer's juice receptacle different from (29) press cavity outer edge of ⅛ which is flat perimeter face where the hinge's opposite extreme is join to (18) ⅛ juicer receptacle (16) squeezer's short lower handle and (28) ⅛ press cavity and (26) squeezer's upper short handle which can present (110) types of handles (plain, circle and with emptying), (170) handle's textures; which can present (15) Juicer receptacle holes or can be closed like a container; (10) ¼ juice receptacle in its lower side can have (14) bottom reinforcements of the juicer receptacle like a base or plain base.

Where (4) circular two-piece squeezer with small handle and adjustable hinge presents a (30) circular juicer receptacle that can present (120) Pick types (plain, dropper, triangular and circular) which is joined through a (13) lower hinge adjustable join directly to (30) circular juicer receptacle which has a circular configuration with a less diameter central edge embedded to allow the adjustment with (23) upper hinge connector which presents a half circumference adjustable with the central edge of part (13) lower adjustable hinge which can offer (140) Hinge types (two pieces adjustable, attachable, edge and plain or one piece) which, in turn, is in direct contact with (31) circular pressing cavity which presents the same geometrical arrangement as (30) circular juicer receptacle unlike (29) external side of the press cavity which is a plain perimeter face where the hinge opposite extreme is join to (30) circular juicer receptacle, (16) Juicer's short lower handle and (31) circular pressing cavity and (26) upper short handle which can present (110) types of handles (plain, circle and with emptying), (170) handle's textures; which can present (15) Juicer receptacle holes or can be closed like a container; (10) ¼ juice receptacle in its lower side can have (14) bottom reinforcements of the juicer receptacle like a base or plain base.

Where (5) one piece squeezer with hinge included presents a (18) ⅛ receptacle of squeezer juice which is rounded in its base and joined with (11) receptacle pick through inclined walls that reach the upper border and can present (120) Pick types (plain, dropper, triangular and circular) which is joined through (40) an only hinge directly joined to (18) squeezer's juice ⅛ receptacle which is directly contact to (28) ⅛ press cavity that presents the same geometrical arrangement as (18) ⅛ juice receptacle unlike (29) external side of the press cavity which is a plain perimeter face where the hinge opposite extreme is join to (18) squeezer's ⅛ juice receptacle to (16) short lower handle and (28) ⅛ press cavity and (26) squeezer's upper short handle which can present (110) types of handles (plain, circle and with emptying), (170) handle's textures; which can present (15) Juicer receptacle holes or can be closed like a container;(18) squeezer's ⅛ juice receptacle in its lower part can present (14) lower reinforcements of the squeezer's receptacle in base or plain base manner.

Where (6) one piece thimble squeezer with hinge included presents a (38) squeezer's juice receptacle which is rounded in its base and is joined with a (11) receptacle pick through inclined walls that reach the upper border and can present (120) Pick types (plain, dropper, triangular and circular) which is joined through (40) an only hinge directly joined to (38) squeezer's juice receptacle which is directly joined with (39) press cavity which presents the same geometrical arrangement as (38) squeezer's juice receptacle which does not have any kind of handles which can present (15) juice receptacle holes or is closed as a container; the (38) squeezer's juice receptacle in its lower part can present (14) bottom reinforcements of the squeezer's receptacle as a base or flat base; where can be attached the (140) hinges (adjustable of two pieces, hook type, edge type and plain or in one piece).

Where (50) triangle squeezer with two pieces base with little handle and edge hinge presents (43) triangular receptacle for the juice of the squeezer whose base is triangular and can be joined to (120) Pick types (plain, dropper, triangular and circular) which is joined through (45) and hinge lower edge type adjustable which is directly joined to (43) squeezer's juice triangular receptacle, which is joined to (44) press triangular cavity which presents the same geometrical arrangement as (43) squeezer's juice triangular receptacle where in the opposite extreme is joined through a hinge to (43) triangular squeezer's juice receptacle and (16) squeezer's short lower handle and (44) triangular press cavity to (26) upper short handle of the squeezer that can present (110) types of handles (plain, circle and with emptying), (170) handle's textures; which can present (15) Juicer receptacle holes or can be closed like a container; (43) squeezer's triangular receptacle in its lower part presents (47) plain base of the triangular receptacle where its configuration (70) solid press cavity squeezer presents a complete or partial fill of material in the cavity, being ¼ or ⅛, round or triangular, and configuration (80) of the squeezer with half circle fund presents a steeper bow where its height can vary in ¼ or ⅛; and its setting (130) squeezer with press cavity with windows presents one or more windows in the squeezers of ¼, ⅛, circle, triangular or thimble type, or (160) cup with close cavity.

Where (100) Cup or cocktail type Juicer, (150) thimble cup without handle presents a cup form which in its press cavity integrates a triangular acute form and can have (15) Juicer receptacle holes presenting (110) types of handles (plain, circle and with emptying), (170) handle's textures; (120) Pick types (plain, dropper, triangular and circular), (140) Hinges (adjustable of two pieces, hook type, edge type and plain or in one piece).

Where manufacturing and assembly process of the LESS THAN ONE-HALF PORTION FOOD MINI-JUICER (¼, ⅛ and irregulars) with removable pieces presents a handle which has an elongated or short configuration and is joined to a cavity like press and a receptacle as a container of the juice which are joined through a hinge presenting three manufacturing and assembly ways:
a—The first one is obtained through the manufacturing mold of one piece when presents (40) an only entire hinge piece, which can be of ¼ or ⅛, rounded, triangular or thimble type.
b—The second: when we have two pieces fitted or disassembled through two molds that presents (140) hinges (adjustable of two pieces, hook type, edge type and plain or in one piece), which can be ¼ or ⅛, rounded, triangular or thimble type.
c—Third: when we require apart from both molds, a (19) hinge pass pin that integrates both mold parts, which can be ¼ or ⅛, rounded, triangular or thimble type.

1. A Less than one-half portion food mini-juicer (¼-⅛ and irregulars) with removable parts comprising: a handle which has an elongated or short setting and are joined by a press cavity and a receptacle which functions like a juice container and are linked through a hinge due to its configuration (1) the squeezer presents: ¼ in two pieces with a handle where: (10) ¼ receptacle or (18) ⅛ receptacle or (30) circular receptacle or (38) thimble receptacle of an only piece or (43) triangular receptacle of the squeezer's juice joined with two lateral walls tilted that present borders (120) Pick types (plain, dropper, triangular and circular) where the food portion is received and is press for (20) a ¼ press cavity or (28) ⅛ press cavity or (31) circular press cavity or (39) one piece thimble cavity or (44) triangular press cavity or (70) solid press cavity which are joined through some (140) Hinges (adjustable of two pieces, hook type, edge type and plain or in one piece) that unit the cavity with the receptacle through an extreme; and for the opposite extreme are joined (110) handles (plain, circular and with emptying), (170) handle textures except for the configuration (6) thimble squeezer which does not present any handle type, (140) Hinges (adjustable of two pieces, hook type, edge type and plain or in one piece) presents and unit the cavity with the receptacle except for (2) two pieces squeezer with cotter that have an additional piece (19) cotter pin hinge where configuration (40) entire hinge of one piece allows to have (5) one piece squeezer or (6) thimble squeezer in one piece; also presents (3) ⅛ squeezer with small handle of two pieces with an adjustable hinge, (4) circular squeezer of two pieces with small handle and attachable hinge, (50) triangular squeezer with two pieces base, little handle and edge hinge, (60) hinge squeezer plain type, (70) squeezer type: solid press cavity, (80) half circular fund squeezer in cavity and receptacle, (100) cup or cocktail squeezer, (150) thimble cup without handle and (130) press cavity squeezer with windows or (160) close cavity cup.

2. A Less than one-half portion food mini-juicer (¼-⅛ and irregulars) with removable parts comprising: a handle which has an elongated or short setting and are joined by a press cavity and a receptacle which functions like a juice container and are linked through a hinge in accordance with underscore 1 as (1) the squeezer presents: ¼ in two pieces with a handle where: (10) ¼ receptacle which is rounded in its base and joined to (11) receptacle pick through inclined walls that reach the upper border that can present (120) Pick types (plain, dropper, triangular and circular) which is joined through an (13) adjustable lower hinge that are directly linked to (10) ¼ juice receptacle which has a rounded configuration carrying out a central edge of less diameter to reach the adjustment with (23) upper adjustable hinge which presents a half circumference adjustable with the central edge of (13) lower adjustable hinge that can present (140) Hinges types (adjustable of two pieces, hook type, edge type and plain or in one piece) which is in direct contact with (20) ¼ press cavity presenting the same geometrical arrangement as (10) ¼ squeezer's juice receptacle, different from (21) external border of ¼ press cavity which is a perimeter flat face and where the opposite extreme is a hinge joined to (10) ¼ receptacle of the squeezer juice the (12) long lower handle of the squeezer and (20) ¼ press cavity and (22) long upper handle of the squeezer that can present (110) handle types (plain, circular and with emptying), (170) handle textures that can present (15) receptacle juice holes or can be close like a container, the (10) ¼ receptacle of the squeezer's juice in its lower part can present (14) lower reinforcements of the juicer receptacle in base or plain base manner.

3. A Less than one-half portion food mini-juicer (¼-⅛ and irregulars) with removable parts comprising: a handle which has an elongated or short setting and are joined by a press cavity and a receptacle which functions like a juice container and are linked through a hinge in accordance with underscore 1 as (2) ⅛ squeezer in two pieces with an interlock presenting a (18) ⅛ receptacle of the squeezer's juice which is rounded in its base and joined to (11) receptacle pick through inclined walls that reach the upper border that can present (120) Pick types (plain, dropper, triangular and circular) which is joined through a (17) lower hinge directly joined to (18) ⅛ receptacle of the squeezer's juice having a rounded configuration which has a perforated bung for (19) hinge pass pin to allow the adjustment with (27) upper pass hinge that presents a half circle like a bung for (19) hinge pass pin directly unit to (28) ⅛ press cavity presenting the same geometrical arrangement as (18) ⅛ juice squeezer's receptacle, different from (29) external border of ⅛ press cavity which has a plain perimeter where the opposite extreme of the hinge is joined to (18) ⅛ receptacle of the juicer and (16) upper short handle of the juicer and (28) ⅛ press cavity the (26) upper short handle of the squeezer can present: (110) handle types (plain, circular and with emptying), (170) handle textures that can present (15) receptacle juice holes or can be close like a container, the (10) ¼ receptacle of the squeezer's juice in its lower part can present (14) lower reinforcements of the juicer receptacle in base or plain base manner.

4-10. (canceled)
